(19) United States
(12) Patent Application Publication
(10) Pub. No.: US 2025/0265330 A1
(43) Pub. Date: Aug. 21, 2025

(54) CODE PROTECTION SYSTEM, METHOD, VIRTUAL SYSTEM ARCHITECTURE, CHIP AND ELECTRONIC DEVICE

(71) Applicant: HYGON INFORMATION TECHNOLOGY CO., LTD., Tianjin (CN)

(72) Inventor: Zhiwei YING, Tianjin (CN)

(73) Assignee: HYGON INFORMATION TECHNOLOGY CO., LTD., Tianjin (CN)

(21) Appl. No.: 18/571,626

(22) PCT Filed: Mar. 3, 2023
(86) PCT No.: PCT/CN2023/079580

§ 371 Date: Dec. 18, 2023

(30) Foreign Application Priority Data
Nov. 7, 2022 (CN) 202211385501.7

(51) Int. Cl. G06F 21/53; G06F 9/455; G06F 12/1009

(52) U.S. Cl. CPC G06F 21/53; G06F 9/45558; G06F 12/1009; G06F 2009/45583; G06F 2009/45587

(57) ABSTRACT

The present disclosure provides a code protection system, a method, a virtual system architecture, a chip, and an electronic device, and the system includes: a heterogeneous acceleration resource configured for the code protection system, in which the heterogeneous acceleration resource is configured to execute a code execution task of a piece of software, and the code execution task includes running code of the software and/or accessing data of the software; a heterogeneous acceleration module, which is configured to allocate the code execution task to the heterogeneous acceleration resource configured for the code protection system; and a heterogeneous acceleration driving module, which is configured to drive the heterogeneous acceleration resource configured, to execute the code execution task allocated.

### CROSS-REFERENCE TO RELATED APPLICATION

The present application claims the priority to Chinese Patent Application No. 202211385501.7, filed on Nov. 7, 2022, the entire disclosure of which is incorporated herein by reference as portion of the present application.

### TECHNICAL FIELD

Embodiments of the present disclosure relate to a code protection system, a method, a virtual system architecture, a chip, and an electronic device.

### BACKGROUND

Software code protection refers to providing security protection for code of a piece of software, including providing data confidentiality protection for software code, and providing data integrity protection for software code.

A code protection solution may combine encryption technology and hardware isolation technology, to provide an independent virtual runtime environment for software code, and cause the virtual runtime environment to run in a hardware environment isolated by an Operating System (OS) of a host, so as to implement software code protection.

However, the computing power of the above-mentioned code protection solution is insufficient, and how to improve the computing power of the code protection solution has always been a problem studied by those skilled in the art.

### SUMMARY

In view of this, the embodiments of the present disclosure provide a code protection system, a method, a virtual system architecture, a chip, and an electronic device, to enhance the computing power of the code protection solution.

To achieve the above-mentioned objectives, the embodiments of the present disclosure provide technical solutions below:

The embodiments of the present disclosure provide a code protection system, comprising:
a heterogeneous acceleration resource configured for the code protection system, in which the heterogeneous acceleration resource is configured to execute a code execution task of a piece of software, and the code execution task comprises running code of the software and/or accessing data of the software;
a heterogeneous acceleration module, which is configured to allocate the code execution task to the heterogeneous acceleration resource configured for the code protection system;
and a heterogeneous acceleration driving module, which is configured to drive the heterogeneous acceleration resource configured, to execute the code execution task allocated.

Optionally, the heterogeneous acceleration resource is a heterogeneous acceleration device or a virtual heterogeneous module, and the heterogeneous acceleration resource is configured by a virtual machine monitor to the code protection system.

Optionally, the virtual heterogeneous module is created by the virtual machine monitor based on a heterogeneous device driver corresponding to the heterogeneous acceleration device, and different virtual heterogeneous modules correspond to different memory regions within the heterogeneous acceleration device.

Optionally, the heterogeneous acceleration resource only executes the code execution task of the code protection system configured.

Optionally, the code execution task is configured with identity information of the code protection system, and the heterogeneous acceleration resource is configured to execute the code execution task when the identity information of the code protection system to which the code execution task allocated for execution belongs matches identity information pre-configured of the code protection system.

Optionally, the heterogeneous acceleration driving module being configured to drive the heterogeneous acceleration resource configured, to execute the code execution task allocated, comprises:
accessing the heterogeneous acceleration resource based on a memory-mapped I/O interface.

Optionally, the code protection system further comprises a secure memory, and task code and/or task data configured to execute the code execution task are stored in the secure memory.

Optionally, the heterogeneous acceleration resource comprises a command processor and a direct memory access DMA module;
the command processor is configured to determine an address of the task code and/or the task data to be accessed, based on task information of the code execution task allocated by the heterogeneous acceleration resource;
and the DMA module is configured to send a memory data access request to an input/output memory management unit, according to the address of the task code and/or the task data to be accessed, and receive the task code and/or the task data transmitted by the input/output memory management unit.

Optionally, the command processor determines identity information of the code protection system corresponding to the code execution task, based on the code execution task executed by the heterogeneous acceleration resource, and configures the identity information to the memory data access request.

Optionally, the code protection system is configured to provide a software-based trusted execution environment, and/or the code protection system is configured to provide a runtime environment for secure multi-party computation and/or federal learning.

The embodiments of the present disclosure further provide a code protection method, which is applied to a code protection system, the code protection system is configured with a heterogeneous acceleration resource, and the code protection method comprises:
acquiring a code execution task, in which the code execution task comprises running code of a piece of software and/or accessing data of the software;
allocating the code execution task to the heterogeneous acceleration resource configured for the code protection system;
and driving the heterogeneous acceleration resource configured, to execute the code execution task allocated.

Optionally, the code execution task is configured with identity information of the code protection system, so that the heterogeneous acceleration resource executes the code execution task when the identity information of the code protection system to which the code execution task allocated for execution belongs matches identity information pre-configured of the code protection system.

Optionally, driving the heterogeneous acceleration resource configured, to execute the code execution task allocated, comprises:
accessing the heterogeneous acceleration resource based on a memory-mapped I/O interface.

Optionally, the task code and/or the task data configured to execute the code execution task are stored in a secure memory, and the code protection method further comprises:
transmitting the task code and/or the task data to the heterogeneous acceleration resource, based on a memory data access request of the heterogeneous acceleration resource, in which the memory data access request is sent based on an address of the task code and/or the task data to be accessed by the heterogeneous acceleration resource as determined by task information of the code execution task.

Optionally, the memory data access request is configured with identity information of the code protection system, and the identity information is determined based on the code execution task executed by the heterogeneous acceleration resource; and transmitting the task code and/or the task data to the heterogeneous acceleration resource, based on the memory data access request of the heterogeneous acceleration resource, comprises:
determining whether the identity information matches an address accessed by the memory data access request;
and if matches, transmitting the task code and/or the task data to the heterogeneous acceleration resource.

The embodiments of the present disclosure further provide a virtual system architecture, comprising a secure virtual machine, a virtual machine monitor, and a heterogeneous acceleration device, and the secure virtual machine is the code protection system according to any one of the embodiments of the present disclosure.

Optionally, the virtual machine monitor is configured to configure a heterogeneous acceleration resource for the secure virtual machine; the heterogeneous acceleration resource is the heterogeneous acceleration device or a virtual heterogeneous module; and the virtual heterogeneous module is created by the virtual machine monitor based on a heterogeneous device driver corresponding to the heterogeneous acceleration device, and different virtual heterogeneous modules correspond to different memory regions within the heterogeneous acceleration device.

Optionally, the virtual machine monitor is configured to configure a nested page table for the secure virtual machine; and the nested page table is configured to indicate a mapping relationship between a user physical address of the secure virtual machine to a host physical address of the heterogeneous acceleration resource.

Optionally, the virtual system architecture further comprises a secure memory and an input/output memory management unit, the secure memory is configured to the secure virtual machine, and task code and/or task data configured to execute the code execution task are stored in the secure memory;
and the input/output memory management unit is configured to receive a memory data access request sent by the heterogeneous acceleration resource, and transmit the task code and/or the task data to the heterogeneous acceleration resource based on the memory data access request.

Optionally, the memory data access request is configured with identity information corresponding to the secure virtual machine, and the input/output memory management unit being configured to transmit the task code and/or the task data to the heterogeneous acceleration resource based on the memory data access request, comprises:
determining whether the identity information matches an address accessed by the memory data access request;
and if matches, transmitting the task code and/or the task data to the heterogeneous acceleration resource.

The embodiments of the present disclosure further provide a chip, comprising the code protection system according to any one of the embodiments of the present disclosure.

The embodiments of the present disclosure further provide an electronic device, comprising the chip according to any one of the embodiments of the present disclosure.

The code protection system provided by the embodiments of the present disclosure comprises: a heterogeneous acceleration resource configured for the code protection system, in which the heterogeneous acceleration resource is configured to execute a code execution task of a piece of software, and the code execution task comprises running code of the software and/or accessing data of the software; a heterogeneous acceleration module, which is configured to allocate the code execution task to the heterogeneous acceleration resource configured for the code protection system; and a heterogeneous acceleration driving module, which is configured to drive the heterogeneous acceleration resource configured, to execute the code execution task allocated.

By directly configuring the heterogeneous acceleration resource for the code protection system and setting corresponding modules, the embodiments of the present disclosure enable the code protection system to directly drive the heterogeneous acceleration resource configured thereby to execute the code execution task allocated, so as to invocate a heterogeneous acceleration device without through a host, which enhances the computing power of the system under the premise of safeguarding data security.

### BRIEF DESCRIPTION OF DRAWINGS

In order to more clearly illustrate the embodiments of the present disclosure, the drawings to be used in the embodiments will be briefly described below, and it will be obvious that the drawings in the following description are only embodiments of the present disclosure, and that other drawings may be obtained by those ordinarily skilled in the art according to the drawings provided, without inventive work.

FIG. 1 is a schematic diagram of a system architecture of a virtualization environment based on secure virtualization technology;

FIG. 2 is an optional structure of a code protection system provided by at least one embodiment of the present disclosure;

FIG. 3 is a schematic diagram of a system architecture of a virtualization environment based on secure virtualization technology provided by at least one embodiment of the present disclosure; and

FIG. 4 is a flowchart of a code protection method provided by at least one embodiment of the present disclosure.

### DETAILED DESCRIPTION

Software code protection refers to providing security protection for code of a piece of software, not only providing data confidentiality protection for software code, but also providing data integrity protection for software code; and the software referred to here is not limited to application software, but may also be system software.

A code protection solution may combine encryption technology and hardware isolation technology, to provide an independent virtual runtime environment for software code, and cause the virtual runtime environment to run in a hardware environment isolated by an Operating System (OS) of a host, so as to implement software code protection.

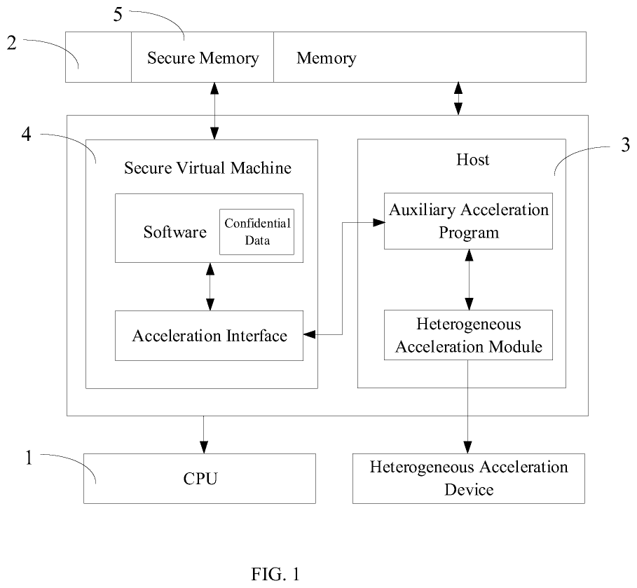

In a specific implementation, the software code protection solution may be implemented based on secure virtualization technology, and the secure virtualization technology is virtualization technology improved on the basis of conventional virtualization technology, that can provide secure protection for a virtual machine memory; referring to FIG. 1, which shows a schematic diagram of a system architecture of a virtualization environment based on secure virtualization technology, the system architecture may include a Central Processing Unit (CPU) 1, a memory 2, a host 3, and a secure virtual machine 4.

For example, the CPU1 is served as a data processing core, and is configured to provide a hardware foundation of data processing for the host 3 and the secure virtual machine 4; the memory 2 is served as a data storage device, and is configured to store data of the host 3 and the secure virtual machine 4; the host 3 may virtualize a plurality of secure virtual machines 4 based on secure virtualization technology; and the secure virtual machine 4 runs independently in a hardware environment isolated by an Operating System (OS) of the host 3.

The secure virtual machine 4 may provide an independent virtual runtime environment for the software code through encryption technology and hardware isolation technology. For example, memory data is encrypted and stored through memory encryption technology, and memories of different secure virtual machines are encrypted with different keys, even the host is incapable of accessing the keys, thereby ensuring security of data of the secure virtual machines. Or, with further reference to FIG. 1, a secure memory 5 is set in the memory 2 by using hardware isolation technology, different secure virtual machines are configured with different regions of the secure memory, and the secure memory only allows access to a correspondingly configured secure virtual machine, thereby ensuring security of data of the secure virtual machine.

The secure virtual machine 4 may be understood as a Trusted Execution Environment (TEE), which may be served as an optional code protection system to protect confidential data (e.g., code) of software. The secure virtual machine 4 may adopt different encryption standards for encryption, and it should be noted that a virtual machine generated by using China's national standard encryption secure virtualization technology may be referred to as a China Secure Virtualization (CSV) virtual machine.

However, the computing power of such a software code protection solution is insufficient. This is because in such a software code protection solution, the secure virtual machine may only utilize a hardware resource of the CPU for data computation, which has limited computation resource, resulting in insufficient computing power.

In an optional implementation, with further reference to FIG. 1, the secure virtual machine may utilize an auxiliary acceleration program and a heterogeneous acceleration module in the host through an acceleration interface, to invocate the heterogeneous acceleration device for data auxiliary computation. The heterogeneous acceleration device may be understood as a computing device with a structure different from the CPU, which has strong computing power for specific types of data processing tasks. However, such a mode requires data interaction with the host, making it difficult to ensure data security.

On this basis, in order to ensure data security, the secure virtual machine, as a code protection system, may only distinguish the code and the data of the software, and isolate the confidential data of the software that needs security protection (the data of the software that needs security protection may be referred to as confidential data, and non-secure data of the software may be referred to as ordinary data) within the secure virtual machine, and after the confidential data related flow is completed, desensitize the data, so that the desensitized data is no longer sensitive; and then the desensitized data and the ordinary data are computed by the heterogeneous acceleration device.

Obviously, the above-mentioned flow is too complex with a high risk of data leakage, so that improvement in computing power of the secure virtual machine is not significant.

Based on this, the embodiments of the present disclosure provide a code protection system. By directly configuring the heterogeneous acceleration resource for the code protection system and setting corresponding modules, the embodiments of the present disclosure enable the code protection system to directly drive the heterogeneous acceleration resource configured thereby to execute the code execution task allocated, so as to invocate a heterogeneous acceleration device without through a host, which enhances the computing power of the system under the premise of safeguarding data security.

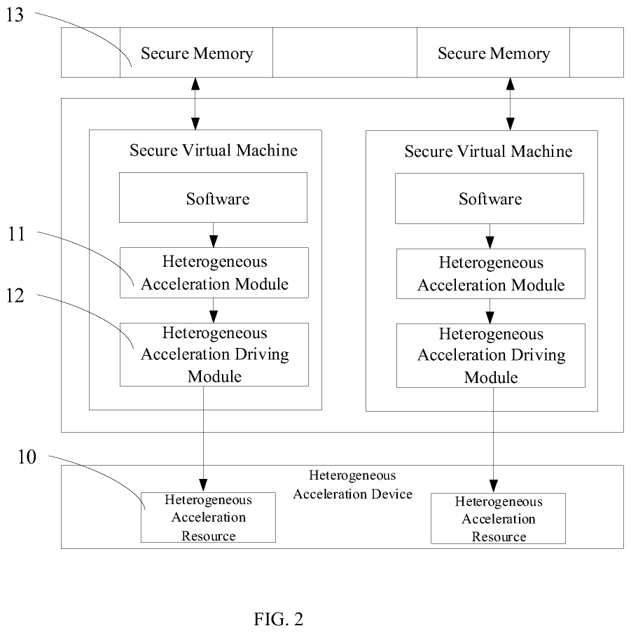

Referring to an optional structure of a code protection system shown in FIG. 2, the code protection system may include a heterogeneous acceleration resource 10, a heterogeneous acceleration module 11, and a heterogeneous acceleration driving module 12.

The heterogeneous acceleration resource 10 may be a heterogeneous acceleration device in a hardware architecture, or may also be a virtual heterogeneous module in a software architecture. The virtual heterogeneous module may be understood as computing power and/or a spatial resource decomposed from the heterogeneous acceleration device, which may be an independent module at a software level, and is capable of performing a corresponding task based on the computing power and/or the spatial resource decomposed thereby. By taking the virtual heterogeneous module as the heterogeneous acceleration resource for configuration, the computing power and/or the spatial resource in the heterogeneous acceleration device may be allocated according to actual needs, thereby maximizing utilization of hardware resources.

For example, the heterogeneous acceleration device may be a peripheral device, and correspondingly, the heterogeneous acceleration resource may be a peripheral device resource. The peripheral device may be, for example, a Graphics Processing Unit (GPU), a General-Purpose Computing On Graphics Processing Unit (GPGPU), a deep computing unit, an Artificial Intelligence (AI) accelerator, a Field-Programmable Gate Array (FPGA), etc., and other devices are configured to provide computing power and/or spatial resource; and accordingly, the heterogeneous acceleration resource may be configured to execute a code execution task of the software, for example, graphics processing, AI acceleration, etc.

It should be noted that the heterogeneous acceleration resource configured for the code protection system is an exclusive resource that only executes the code execution task of the configured code protection system, and does not execute any task of other code protection system or host system, thereby isolating the heterogeneous acceleration resource configured for the code protection system. In an optional example, the heterogeneous acceleration resource configured for the code protection system may be isolated based on hardware isolation technology, thereby implementing data isolation protection.

In a specific example, the heterogeneous acceleration resource may confirm the configured code protection system configured by the heterogeneous acceleration resource based on identity information of the code protection system, and execute a corresponding code execution task when the identity information of the code protection system to which the code execution task belongs matches identity information of the pre-configured code protection system. It should be noted that the identity information of the code protection system may be identity information of the software, or may also be the identity information configured by the system for indicating the identity of the code protection system.

For example, the heterogeneous acceleration resource configured for the code protection system may be one or more, which will not be specifically limited in the present disclosure.

It may be understood that by configuring the heterogeneous acceleration resource for the code protection system, the code protection system can directly drive the heterogeneous acceleration resource configured thereby, so that the heterogeneous acceleration resource can be combined into the trusted execution environment provided by the code protection system, which enhances the computing power of the code protection system under the premise of ensuring data security.

The code execution task may be understood as a task that needs to be executed in a flow running the software, and the software is run through one or more code execution tasks. For example, the code execution task includes running code of the software and/or accessing data of the software.

It should be noted that, according to the embodiments of the present disclosure, the code protection system can directly drive the heterogeneous acceleration resource configured thereby, by directly configuring the heterogeneous acceleration resource for the code protection system and setting a corresponding module, so that all the data in the software may be processed in the trusted execution environment; and accordingly, the code and the data in the software according to the embodiments of the present disclosure do not need to be distinguished between secure code and ordinary code, and between secure data and ordinary data, based on the need for security protection.

The heterogeneous acceleration module 11 is configured to allocate a code execution task to the heterogeneous acceleration resource configured for the code protection system. For example, the heterogeneous acceleration module may determine the code execution task to be executed by the heterogeneous acceleration resource based on type of the code execution task, and task execution efficiency of the code protection system, etc., thereby allocating a corresponding code execution task to the heterogeneous acceleration resource.

The heterogeneous acceleration driving module 12 is configured to drive the configured heterogeneous acceleration resource to execute the code execution task. For example, after determining the code execution task allocated by the heterogeneous acceleration resource configured for the code protection system, the heterogeneous acceleration driving module may send task information of the allocated code execution task to the heterogeneous acceleration resource, thereby driving the heterogeneous acceleration resource to execute the allocated code execution task.

In an optional example, the heterogeneous acceleration module 11 and the heterogeneous acceleration driving module 12 may be configured within a secure virtual machine, and the secure virtual machine is configured to provide an operating system with an isolated environment for the code protection system and provide code protection for software running within the isolated environment.

In a further optional example, the code protection system further includes a secure memory 13 configured for the code protection system, and the secure memory 13 is configured to the code protection system based on encryption technology and/or hardware isolation technology. For example, the secure memory 13 only allows access based on the identity information of the code protection system, to ensure data security of the code protection system.

It may be understood that the heterogeneous acceleration resource may perform identity confirmation of the code protection system allocating the code execution task based on the identity information configured in the code execution task, and may also access task code and/or task data stored in the secure memory for executing the code execution task based on the identity information and the task information of the code execution task, thereby executing the code execution task.

In the code protection system provided by the embodiments of the present disclosure, by configuring the heterogeneous acceleration resource for the code protection system, and by setting the heterogeneous acceleration module and the heterogeneous acceleration driving module, the code protection system can directly allocate the code execution task to the heterogeneous acceleration resource, and drive the heterogeneous acceleration resource to execute the allocated code execution task, so as to invocate the heterogeneous acceleration device without through the host, which enhances the computing power of the system under the premise of safeguarding data security.

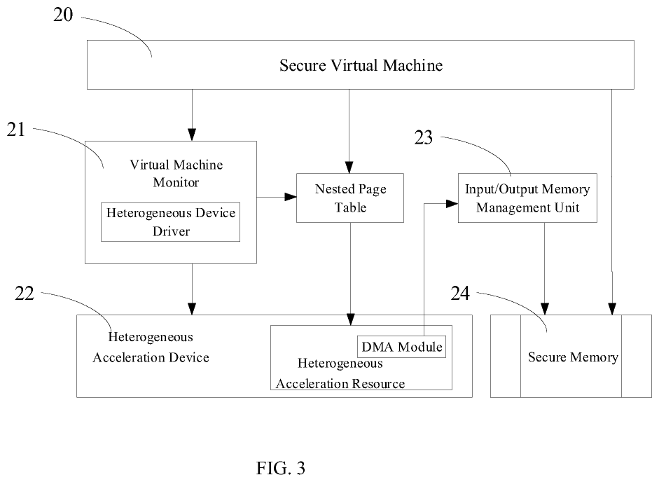

In a further optional example, referring to FIG. 3, the embodiments of the present disclosure further provide a system architecture of a virtualization environment based on secure virtualization technology (which may also be referred to as a virtual system architecture), and the virtual system architecture includes a secure virtual machine 20, a Virtual Machine Monitor (VMM) 21, a heterogeneous acceleration device 22, an Input/Output Memory Management Unit (IOMMU) 23 and a secure memory 24.

The secure virtual machine 20 may be understood as a code protection system, and is configured to provide a trusted execution environment for running software; the virtual machine monitor 21 is a management module configured in the host system, and is configured to maintain/configure a page table, resource allocation, etc. of the secure virtual machine; the heterogeneous acceleration device 22 is configured to provide a heterogeneous acceleration resource for the code protection system; and the input/output memory management unit 23 is configured to collaboratively implement data transmission between the heterogeneous acceleration device and the secure memory 24.

The heterogeneous acceleration device 22 may be configured as one or more heterogeneous acceleration resources to the secure virtual machine. In the case where the heterogeneous acceleration device is configured as a plurality of heterogeneous acceleration resources, the virtual machine monitor may create a plurality of virtual heterogeneous modules for the heterogeneous acceleration device based on a heterogeneous device driver of a corresponding heterogeneous acceleration device; different virtual heterogeneous modules correspond to different hardware resources of the heterogeneous acceleration device; and one virtual heterogeneous module is served as one heterogeneous acceleration resource. For example, different virtual heterogeneous modules correspond to different memory regions within the heterogeneous acceleration device, and thus may be configured as different heterogeneous acceleration resources to different secure virtual machines at a software level.

When the secure virtual machine needs to be configured with the heterogeneous acceleration resource (e.g., when starting the secure virtual machine, or when creating the secure virtual machine), the heterogeneous acceleration resource may be configured by the virtual machine monitor. It should be noted that in other examples, the configuration may also be performed by the OS system of the host or other entity having heterogeneous acceleration resource configuration permission, and the present disclosure will be illustrated by taking the virtual machine monitor as an example.

Specifically, the virtual machine monitor may configure the corresponding heterogeneous acceleration resource (e.g., the virtual heterogeneous module) to the secure virtual machine through the heterogeneous device driver configured thereby, allowing the secure virtual machine to directly access the heterogeneous acceleration resource, so as to implement direct access of the secure virtual machine to the heterogeneous acceleration resource for use. For example, the direct access of the secure virtual machine to the heterogeneous acceleration resource may be implemented based on Memory Mapped I/O (MMIO) interface technology. Specifically, in an optional example, the virtual machine monitor may create and maintain a nested page table corresponding to the heterogeneous acceleration resource for the secure virtual machine, allowing the heterogeneous acceleration driving module of the secure virtual machine to access the heterogeneous acceleration resource by using the MMIO interface based on the nested page table.

It may be understood that the nested page table is configured to indicate a mapping relationship between a user physical address GPA and a host physical address HPA. When creating a nested page table, a corresponding address mapping relationship has not yet been set up. Therefore, when the secure virtual machine accesses the heterogeneous acceleration resource, a missing page exception may occur (i.e., a corresponding HPA cannot be found through the access address GPA given by the secure virtual machine); the virtual machine monitor may capture access of the secure virtual machine to the heterogeneous acceleration resource based on the missing page exception, and then configure an HPA corresponding to the heterogeneous acceleration resource for the GPA of the secure virtual machine, based on the heterogeneous acceleration resource configured for the secure virtual machine. After setting up the address mapping relationship corresponding to the nested page table, the secure virtual machine may directly access the heterogeneous acceleration resource based on the nested page table in a subsequent access process.

Based on the above description, the heterogeneous acceleration resource may be configured for the secure virtual machine so that the secure virtual machine may directly access the heterogeneous acceleration resource. However, in some optional examples, the heterogeneous acceleration resource configured for the secure virtual machine further accesses data in the secure memory. Hereinafter, the process that the heterogeneous acceleration resource accesses the secure memory will be introduced.

It may be understood that during task processing of the software, the corresponding code execution task may need to read other task code in the secure memory or read task data of the software stored in the secure memory; if it is read by the secure virtual machine and then transmitted to the heterogeneous acceleration resource, it will consume corresponding CPU resources and consume a corresponding processing duration.

In some optional examples, in order to improve data transmission efficiency while reducing CPU resource consumption, the heterogeneous acceleration resource may direct access to the data in the secure memory based on Direct Memory Access (DMA) technology, by utilizing the Input/Output Memory Management Unit (IOMMU).

Specifically, the heterogeneous acceleration resource may further include a command processor (not shown) and a DMA module, the command processor may determine an address of the task code and/or the task data to be accessed based on the task information of the code execution task allocated by the heterogeneous acceleration resource; the DMA module may send a memory data access request to the input/output memory management unit, according to the address of the task code and/or the task data to be accessed; and the corresponding task code and/or task data are read by the input/output memory management unit, and then transmitted to the heterogeneous acceleration resource.

In an optional example, in order to ensure data security of the secure virtual machine, the command processor may determine the identity information of the secure virtual machine corresponding to the code execution task, based on the code execution task executed by the heterogeneous acceleration resource, and simultaneously configure the identity information to the memory data access request, which is sent by the DMA module to the input/output memory management unit; and the input/output memory management unit confirms whether the address of the code or the data accessed thereby matches the identity information, and then transmits data between the secure memory and the heterogeneous acceleration resource after confirming the identity information.

In a further optional example, the data stored in the secure memory (including the task code and/or the task data) is encrypted data. Accordingly, the input/output memory management unit may determine a key for the secure virtual machine to store data in the secure memory based on the identity information, and then decrypt the encrypted data in the secure memory based on the key, thereby transmitting the corresponding data (including the task code and/or the task data) to the heterogeneous acceleration resource.

Based on the code protection system provided by the embodiments of the present disclosure, security is guaranteed and computing performance is improved, so that the code protection system may be configured to provide a trusted execution environment based on the software, and/or, the code protection system is configured to provide a runtime environment for secure multi-party computation and/or federal learning.

Secure Multi-Party Computation (MPC) is an important tool in modern cryptography, and huge demand for private data sharing has made MPC highly valued by the cryptography community and developed into a key technology to solve various privacy protection problems. MPC is based on cryptographic algorithm protocols to achieve the purpose of privacy computation, and may be viewed as a comprehensive application of various cryptographic basic tools.

Federal learning (FL) is an emerging artificial intelligence foundational technology, which involves training a model by each institution having a data source, performing iterative interaction optimization on relevant information of the respective models (weight updates and gradient information of the models) in an encrypting manner, and then aggregating the models to obtain a global model. The trained federal learning models are not shared but separately placed among the respective participating parties, and during actual use, cooperate to form predictions.

In a specific example, the code protection system provided by the embodiments of the present disclosure allows MPC software to be executed by directly utilizing computing power of the CPU, or to be executed by utilizing the heterogeneous acceleration resource; and in the case where AI or other heterogeneous acceleration is required in FL, the heterogeneous acceleration resource therein may be used, for example, GPGPU or other acceleration cards may be used.

The system architecture provided by the embodiments of the present disclosure improves data computing performance while ensuring data security, and improves data transmission efficiency.

Based on the code protection system provided by the embodiments of the present disclosure, the embodiments of the present disclosure may further provide a code protection method, so that software may run in a trusted execution environment based on the method.

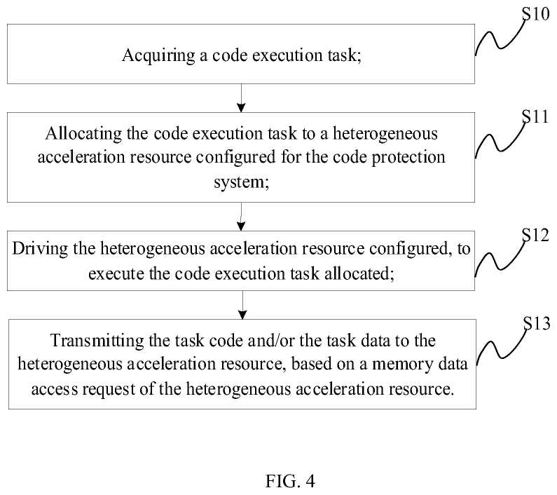

Optionally, FIG. 4 shows a flowchart of a code protection method provided by at least one embodiment of the present disclosure; referring to FIG. 4, the flowchart may be used to describe a flow of code of a piece of software in a code protection system when heterogeneous acceleration is required, and the software in the flow may run in the code protection system provided by the foregoing embodiments; and the content of the code protection method as described below and the content of the code protection system as described above may be mutually referred to.

Referring to FIG. 4, the code protection method may include the following steps.
Step S10: acquiring a code execution task, in which the code execution task includes running code of a piece of software and/or accessing data of the software.
Step S11: allocating the code execution task to a heterogeneous acceleration resource configured for the code protection system.
Step S12: driving the heterogeneous acceleration resource configured, to execute the code execution task allocated.

Optionally, the code execution task is configured with identity information of the code protection system, so that the heterogeneous acceleration resource executes the code execution task when the identity information of the code protection system to which the code execution task allocated for execution belongs matches identity information pre-configured of the code protection system.

Optionally, step S12, driving the heterogeneous acceleration resource configured, to execute the code execution task allocated, may include accessing the heterogeneous acceleration resource based on a memory-mapped I/O interface.

Optionally, the task code and/or the task data configured to execute the code execution task are stored in the memory, and the method further includes the following step.
Step S13: transmitting the task code and/or the task data to the heterogeneous acceleration resource, based on a memory data access request of the heterogeneous acceleration resource.

For example, the memory data access request is sent based on the address of the task code and/or the task data to be accessed by the heterogeneous acceleration resource as determined by task information of the code execution task.

Optionally, the memory data access request is configured with identity information of the code protection system; the identity information is determined based on the code execution task executed by the heterogeneous acceleration resource; and the step S13, transmitting the task code and/or the task data to the heterogeneous acceleration resource, based on the memory data access request of the heterogeneous acceleration resource, includes the following steps.

Determining whether the identity information matches the address accessed by the memory data access request;
and if matches, transmitting the task code and/or the task data to the heterogeneous acceleration resource.

The code protection method provided by the embodiments of the present disclosure can improve data computing performance while ensuring data security, and improve data transmission efficiency.

As an optional implementation, the embodiments of the present disclosure further provide a chip, and the chip includes the code protection system provided by the embodiments of the present disclosure.

As an optional implementation, the embodiments of the present disclosure further provide an electronic device, and the electronic device includes the above-described chip.

The above describes a plurality of embodiments of the present disclosure, and in case of no conflict, the respective optional modes introduced in the respective embodiments may be subjected to mutual combination and cross reference, thereby extending various possible embodiments, which may be considered as disclosed embodiments of the present disclosure.

Although the embodiments of the present disclosure are disclosed as above, the present disclosure is not limited thereto. Any person skilled in the art may make various changes and modifications without departing from the spirit and scope of the present disclosure. Therefore, the protection scope of the present disclosure should be based on the protection scope of the claims.

1. A code protection system, comprising:
a heterogeneous acceleration resource configured for the code protection system, wherein the heterogeneous acceleration resource is configured to execute a code execution task of a piece of software, and the code execution task comprises running code of at least one of the software and accessing data of the software;
a heterogeneous acceleration module, configured to allocate the code execution task to the heterogeneous acceleration resource configured for the code protection system; and
a heterogeneous acceleration driving module, configured to drive the heterogeneous acceleration resource configured, to execute the code execution task allocated.

2. The code protection system according to claim 1, wherein the heterogeneous acceleration resource is a heterogeneous acceleration device or a virtual heterogeneous module, and the heterogeneous acceleration resource is configured by a virtual machine monitor to the code protection system;
the virtual heterogeneous module is created by the virtual machine monitor based on a heterogeneous device driver corresponding to the heterogeneous acceleration device, and different virtual heterogeneous modules correspond to different memory regions within the heterogeneous acceleration device.

3. (canceled)

4. The code protection system according to claim 1, wherein the heterogeneous acceleration resource only executes the code execution task of the code protection system configured.

5. The code protection system according to claim 1, wherein the code execution task is configured with identity information of the code protection system, and the heterogeneous acceleration resource is configured to execute the code execution task when the identity information of the code protection system to which the code execution task allocated for execution belongs matches identity information pre-configured of the code protection system.

6. The code protection system according to claim 1, wherein the heterogeneous acceleration driving module being configured to drive the heterogeneous acceleration resource configured, to execute the code execution task allocated, comprises:
accessing the heterogeneous acceleration resource based on a memory-mapped I/O interface.

7. The code protection system according to claim 1, further comprising a secure memory, wherein at least one of task code and task data are configured to execute the code execution task are stored in the secure memory.

8. The code protection system according to claim 7, wherein the heterogeneous acceleration resource comprises a command processor and a direct memory access DMA module;
the command processor is configured to determine an address of the at least one of the task code and the task data to be accessed, based on task information of the code execution task allocated by the heterogeneous acceleration resource; and
the DMA module is configured to send a memory data access request to an input/output memory management unit, according to the address of the at least one of the task code and the task data to be accessed, and receive the at least one of the task code and the task data transmitted by the input/output memory management unit.

9. The code protection system according to claim 8, wherein the command processor is further configured to determines identity information of the code protection system corresponding to the code execution task, based on the code execution task executed by the heterogeneous acceleration resource, and configures the identity information to the memory data access request; and
at least one of the code protection system is configured to provide a software-based trusted execution environment, and the code protection system is configured to provide a runtime environment for at least one of secure multi-party computation and federal learning.

10. (canceled)

11. A code protection method, applied to a code protection system, wherein the code protection system is configured with a heterogeneous acceleration resource, and the code protection method comprises:
acquiring a code execution task, wherein the code execution task comprises running code of a at least one of a piece of software and accessing data of the software;
allocating the code execution task to the heterogeneous acceleration resource configured for the code protection system; and
driving the heterogeneous acceleration resource configured, to execute the code execution task allocated.

12. The code protection method according to claim 11, wherein the code execution task is configured with identity information of the code protection system, so that the heterogeneous acceleration resource executes the code execution task when the identity information of the code protection system to which the code execution task allocated for execution belongs matches identity information pre-configured of the code protection system.

13. The code protection method according to claim 11, wherein driving the heterogeneous acceleration resource configured, to execute the code execution task allocated, comprises:
accessing the heterogeneous acceleration resource based on a memory-mapped I/O interface.

14. The code protection method according to claim 1, wherein at least one of task code and the task data configured to execute the code execution task are stored in a secure memory, and the code protection method further comprises:
transmitting the at least one of the task code and the task data to the heterogeneous acceleration resource, based on a memory data access request of the heterogeneous acceleration resource, wherein the memory data access request is sent based on an address of the at least one of the task code and the task data to be accessed by the heterogeneous acceleration resource as determined by task information of the code execution task.

15. The code protection method according to claim 14, wherein the memory data access request is configured with identity information of the code protection system, and the identity information is determined based on the code execution task executed by the heterogeneous acceleration resource; and
transmitting the at least one of the task code and the task data to the heterogeneous acceleration resource, based on the memory data access request of the heterogeneous acceleration resource, comprises:
determining whether the identity information matches an address accessed by the memory data access request; and
if matches, transmitting the at least one of the task code and the task data to the heterogeneous acceleration resource.

16. A virtual system architecture, comprising a secure virtual machine, a virtual machine monitor, and a heterogeneous acceleration device, wherein the secure virtual machine is the code protection system according to claim 1.

17. The virtual system architecture according to claim 16, wherein the virtual machine monitor is configured to configure a heterogeneous acceleration resource for the secure virtual machine;
the heterogeneous acceleration resource is the heterogeneous acceleration device or a virtual heterogeneous module; and
the virtual heterogeneous module is created by the virtual machine monitor based on a heterogeneous device driver corresponding to the heterogeneous acceleration device, and different virtual heterogeneous modules correspond to different memory regions within the heterogeneous acceleration device.

18. The virtual system architecture according to claim 16, wherein the virtual machine monitor is configured to configure a nested page table for the secure virtual machine; and
the nested page table is configured to indicate a mapping relationship between a user physical address of the secure virtual machine to a host physical address of the heterogeneous acceleration resource.

19. The virtual system architecture according to claim 1, further comprising a secure memory and an input/output memory management unit,
wherein the secure memory is configured to the secure virtual machine, and the at least one of the task code and the task data configured to execute the code execution task are stored in the secure memory; and
the input/output memory management unit is configured to receive a memory data access request sent by the heterogeneous acceleration resource, and transmit at least one of the task code and the task data to the heterogeneous acceleration resource based on the memory data access request.

20. The virtual system architecture according to claim 19, wherein the memory data access request is configured with identity information corresponding to the secure virtual machine, and the input/output memory management unit being configured to transmit the at least one of the task code and the task data to the heterogeneous acceleration resource based on the memory data access request, comprises:
determining whether the identity information matches an address accessed by the memory data access request; and
if matches, transmitting the at least one of the task code and the task data to the heterogeneous acceleration resource.

21. A chip, comprising the code protection system according to claim 1.

22. An electronic device, comprising the chip according to claim 21.
